(19) United States
(12) Patent Application Publication
(10) Pub. No.: US 2014/0332356 A1
(43) Pub. Date: Nov. 13, 2014

(54) HANDLE TIE APPARATUS FOR G-FRAME 1 POLE BREAKERS

(71) Applicant: EATON CORPORATION, Cleveland, OH (US)

(72) Inventors: KENNETH DANIEL KOLBERG, McKees Rocks, PA (US); ROGER WILLIAM HELMS, Beaver Falls, PA (US)

(73) Assignee: EATON CORPORATION, Cleveland, OH (US)

(21) Appl. No.: 13/888,558

(22) Filed: May 7, 2013

(51) Int. Cl. H01H 9/26

(52) U.S. Cl. CPC H01H 9/26
USPC 200/50.32

(57) ABSTRACT

The disclosed concept relates to a handle tie apparatus for connecting two or more operating handles of two or more electrical switching assemblies for simultaneous operation of the operating handles, such as switching from “on” position to “off” position. The handle tie apparatus including apertures formed therein for receiving the operating handles and slots having barbs configured therein for mechanically engaging and securing the operating handles in said handle tie apparatus.

### BACKGROUND

1. Field

The disclosed concept pertains generally to electrical switching assemblies and, more particularly, to a handle tie apparatus to mechanically connect together the actuator devices of electrical switching assemblies. More particularly, the invention relates to a handle tie apparatus for simultaneously operating a plurality of electrical switching assemblies, such as G-frame 1 pole breakers.

2. Background Information

Electrical switching assemblies include, for example, circuit switching devices and circuit interrupters, such as circuit breakers, contactors, motor starters, motor controllers and other load controllers. Circuit breakers are generally well known in the art. Circuit breakers are used to protect electrical circuitry from damage due to an over current condition, such as an overload condition or a relatively high level short circuit or fault condition. Molded case circuit breakers, for example, include at least one pair of separable contacts which are operated either manually by way of a handle disposed on the outside of the case or automatically by way of an internal trip unit in response to an over current condition.

Circuit breakers typically have two or three possible operating handle positions, corresponding to the status of the separable contacts. For example, these positions may include an ON position, in which the separable contacts are closed, an OFF position in which the contacts are open, and a tripped position in which the contacts are tripped open. Typically, the handle position corresponding to the tripped position of the contacts is between the ON and OFF positions.

In certain applications, single pole circuit breakers are combined to form multiple pole circuit breakers. The individual handles of each of the single pole circuit breakers are typically connected by a handle tie in order that all of the multiple handles can be operated simultaneously. Thus, the handles can be moved simultaneously from an “off” position to an “on” position to energize the electrical switching apparatus or vice versa, from an “on” position to an “off” position to de-energize.

Handle ties are generally known in the art and typically consist of an elongated box-shaped structure open on one long side so that the ends of the operating handles of the electrical switching assemblies may be received within the box. However, there are disadvantages associated with these handle ties and there is a need for an effective handle tie apparatus that can securely engage a plurality of handle operators tier simultaneous operation of the electrical switching assemblies.

Accordingly, there is room for improvement in electrical switching assembly handle the apparatus.

### SUMMARY

These needs and others are met by embodiments of the disclosed concept.

In accordance with one aspect of the disclosed concept, there is provided a handle tie apparatus for connecting generally parallel handles of at least two electrical switching assemblies arranged in a side-by-side relationship. The apparatus includes a rectangular member having a trough shape open at a top and closed at a bottom thereof, a pair of opposing side walls and a pair of opposing end walls defining the rectangular member. A plurality of apertures is formed within the bottom of the rectangular member. The plurality of apertures is adapted for receiving end parts of a corresponding plurality of electrical switching handles. The apparatus further includes a plurality of slots formed in each of the opposing side walls of the rectangular member. The slots in one of the opposing side walls are formed generally in locations which correspond to the slots in the other opposing side wall when aligned. Each of the slots includes a barb configured therein. Each of the barbs is structured to receive and mechanically engage and secure a portion of the corresponding plurality of electrical switching handles.

In accordance with another aspect of the disclosed concept, there is provided an electrical switching assembly adapted for multi-pole operation including a first electrical switching assembly having a first handle extending therefrom for switching said first electrical switching assembly between “on” and “off” positions, and a second electrical switching assembly having a second handle extending therefrom for switching said second electrical switching assembly between “on” and “off” positions. The first and second electrical switching assemblies being connected together with said first and second handles extending generally parallel to each other. A handle tie connects said first and second handles for simultaneous operation thereof. The handle tie has first and second handle apertures disposed therethrough. The handle tie includes the following: a rectangular member having a trough shape open at a top and closed at a bottom thereof; a pair of opposing side walls and a pair of opposing end walls defining the rectangular member; the first and second apertures formed within the bottom of the rectangular member; the first and second apertures adapted for receiving end parts of the first and second handles; first and second slots formed in each of the opposing side walls of the rectangular member, the first and second slots in one of the opposing side walls formed generally in locations which correspond to the first and second slots, respectively, in the other opposing side wall when aligned; each of the first and second slots including a barb configured therein and each of the barbs structured to receive and mechanically engage and secure a portion of the first and second handles, respectively.

### BRIEF DESCRIPTION OF THE DRAWINGS

A full understanding of the disclosed concept can be gained from the following description of the preferred embodiments when read in conjunction with the accompanying drawings in which:

FIG. 1 is an isometric view of a handle tie apparatus, in accordance with certain embodiments of the disclosed concept.

FIG. 2 is a side view of the handle tie apparatus shown in FIG. 1, in accordance with certain embodiments of the disclosed concept.

FIG. 3 is a detailed view of the slot shown in FIG. 2, in accordance with certain embodiments of the disclosed concept.

FIG. 4 is atop view of the handle tie apparatus shown in FIG. 1, in accordance with certain embodiments of the disclosed concept.

FIG. 5 is a front view of a circuit breaker assembly including the handle tie apparatus shown in FIG. 1, in accordance with certain embodiments of the disclosed concept.

FIG. 6 is an isometric view of the circuit breaker assembly shown in FIG. 5, in accordance with certain embodiments of the disclosed concept.

### DESCRIPTION OF THE PREFERRED EMBODIMENTS

The disclosed concept is described in association with electrical switching assemblies, such as circuit breakers and, in particular, G frame 1 pole breakers, although it will become apparent that it could also be applied to other types of electrical switching assemblies (e.g., without limitation, circuit switching devices and other circuit interrupters such as contactors, motor starters, motor controllers and other load controllers).

In certain embodiments, the disclosed concept includes a handle tie apparatus for connecting a plurality of handle operators corresponding to a plurality of electrical switching assemblies. The electrical switching assemblies are arranged in a side-by-side relationship to one another and may be coupled using conventional mechanisms. The operating handles extending from the electrical switching assemblies are generally parallel to each other. The operating handles are employed to switch the electrical switching assemblies between “on” and “off” positions. Employing a handle tie apparatus to connect the plurality of operating handles together allows for simultaneous switching of the operating handles and therefore, simultaneous operation of the electrical switching assemblies.

The handle tie apparatus includes a rectangular member having a trough shape open at a top and closed at a bottom thereof, a pair of opposing side walls and a pair of opposing end walls defining the rectangular member. A plurality of apertures or openings is formed or disposed therethrough within the bottom of the rectangular member. The plurality of apertures is adapted for receiving an end portion of a corresponding plurality of handle operators of the electrical switching assemblies. The number of apertures corresponds to the number of operating handles (and electrical switching assemblies). Further, a plurality of slots is formed in each of the opposing side walls of the rectangular member. When the two opposing side walls are aligned in a parallel relationship, the positions of the slots in one of the opposing side walls generally correspond to the positions of the slots in the other opposing side wall. Each of the slots includes a barb configured therein and is structured to mechanically engage and secure an end portion of a handle operator of an electrical switching assembly. The barb is angled, bent or slanted toward the operating handle. The number of slots in each of the opposing side walls corresponds to the number of operating handles (and electrical switching assemblies). Furthermore, a pair of parallel slots (one from each opposing side wall) generally corresponds to each of the apertures formed in the bottom of the rectangular member.

When the handle tie apparatus is slid over the handle operators, the barbs are designed such that the handle tie apparatus remains securely in place without the need for another means of attaching the handle tie apparatus to the handle operators. Further, the bottom surface of the rectangular member provides a stop to position the handle tie into the handle operators.

The apparatus may be made from any suitable material and structured to be substantially rigid. In certain embodiments, suitable materials include metal, such as but not limited to steel and steel alloy. The metal can be in the for of thin sheet metal. Further, the metal sheet can be configured into a shape, e.g., a rectangular trough-like member, which provides sufficient load capabilities to switch multiple electrical switching assemblies, e.g., circuit breakers.

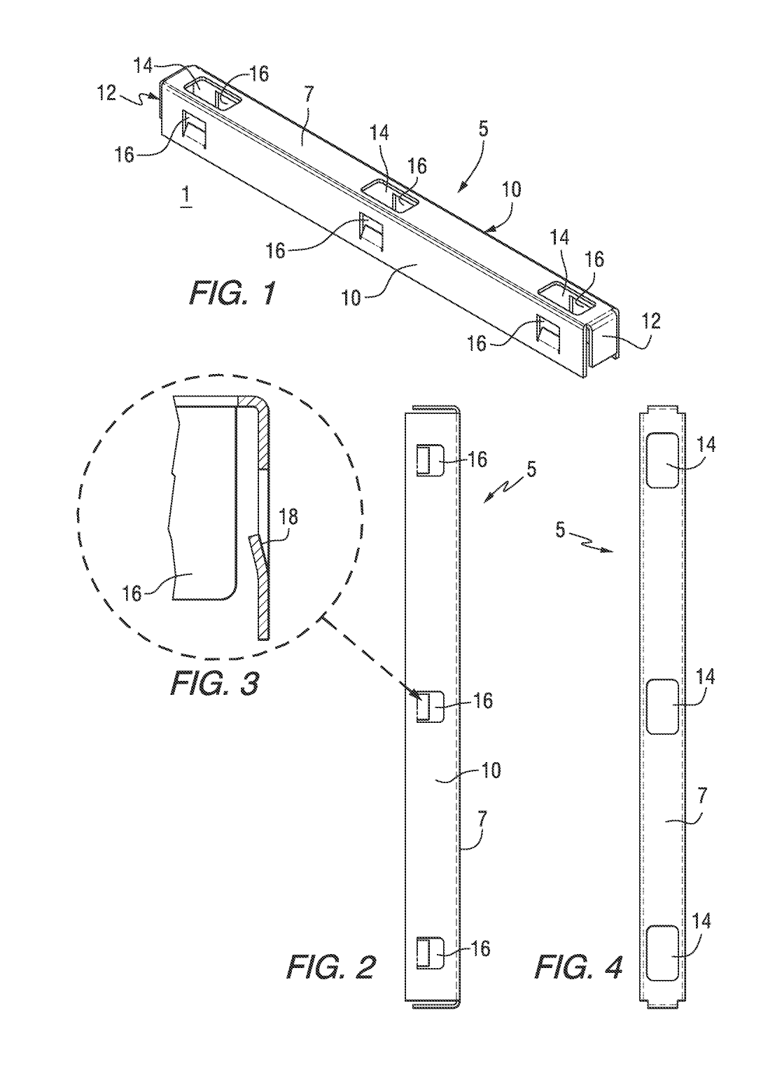

FIG. 1 shows a handle tie 1 in accordance with certain embodiments of the disclosed concept. The handle tie 1 includes a rectangular member 5 having a trough shape open at a top (not shown) and closed at a bottom surface 7 thereof, a pair of opposing side walls 10 and a pair of opposing end walls 12 which define the rectangular member. A plurality of apertures 14 is formed within the bottom surface 7 of the rectangular member 5. The plurality of apertures 14 is adapted for receiving an end portion of a corresponding plurality of handle operators of a plurality of electrical switching assemblies (not shown). Further, a plurality of slots 16 is formed in each of the opposing side walls 10 of the rectangular member 5. When the two opposing side walls 10 are aligned in a parallel relationship, the positions of the plurality of slots 16 in one of the opposing side walls 10 generally correspond to the positions of the plurality of slots 16 in the other one of the opposing side walls 10. Further, the plurality of plurality of slots 16 are spaced apart along each of the opposing side walls 10 to generally correspond to the spaced apart configuration of the plurality of apertures 14 along the bottom surface 7.

FIG. 2 is aside view of the handle tie 1 shown in FIG. 1. FIG. 2 includes the rectangular member 5, the bottom 7, one of the pair of opposing side walls 10 and the plurality of slots 16 formed in the one of the pair of opposing side walls 10.

FIG. 3 is a detailed view of one of the plurality of slots 16 shown in FIG. 2 wherein the slot includes a barb 18. The barb 18 is configured therein and is structured to mechanically engage and secure an end portion of a handle operator (not shown) of an electrical switching assembly (not shown). In certain embodiments, the plurality of apertures 14 are fitted over a corresponding plurality of handle operators on a plurality of electrical switching assemblies and as such, one of the plurality of slots 16 with the barb 18 configured within each of the slots 16, is positioned above and below each of the apertures 14 to engage and secure an end portion of each of the handle operators which aligns with and/or extends through the apertures 14.

FIG. 4 is a top view of the handle tie 1 shown in FIG. 1. FIG. 4 includes the rectangular member 5, the bottom 7, and the plurality of apertures 14 formed in the bottom 7. The plurality of apertures 14 are spaced apart to correspond to a plurality of handle operators on a plurality of electrical switching assemblies (both not shown).

The handle tie 1 can have various lengths to accommodate a number of apertures 14 formed therein for receiving the corresponding number of operating handles. As shown in FIG. 1 and FIG. 4, the handle tie 1 has a length to accommodate three apertures 14. In alternate embodiments, the length can be greater or lesser to accommodate a larger or smaller number of apertures.

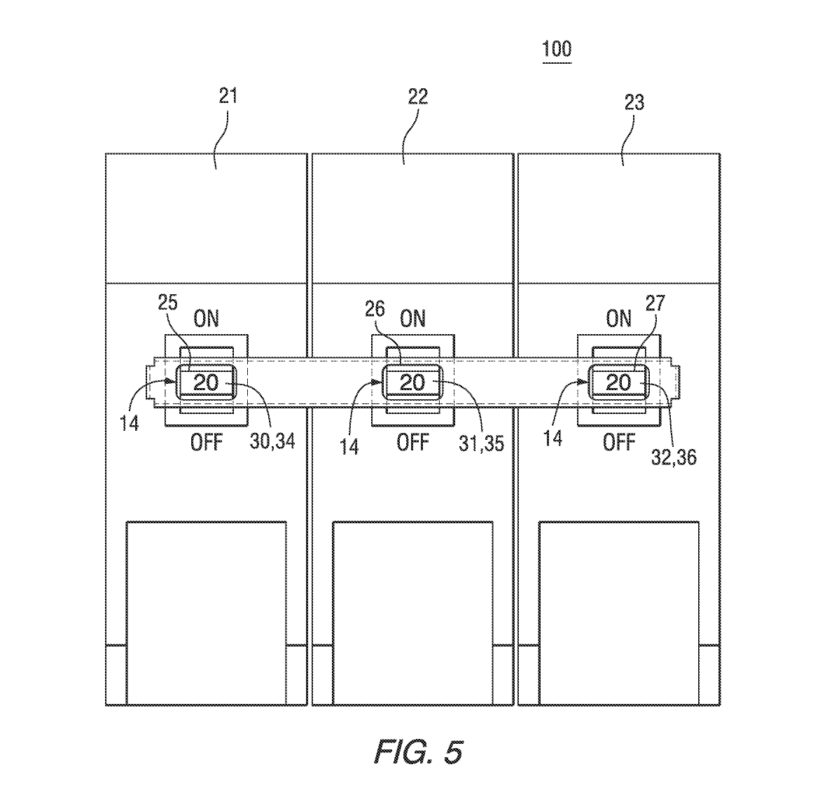

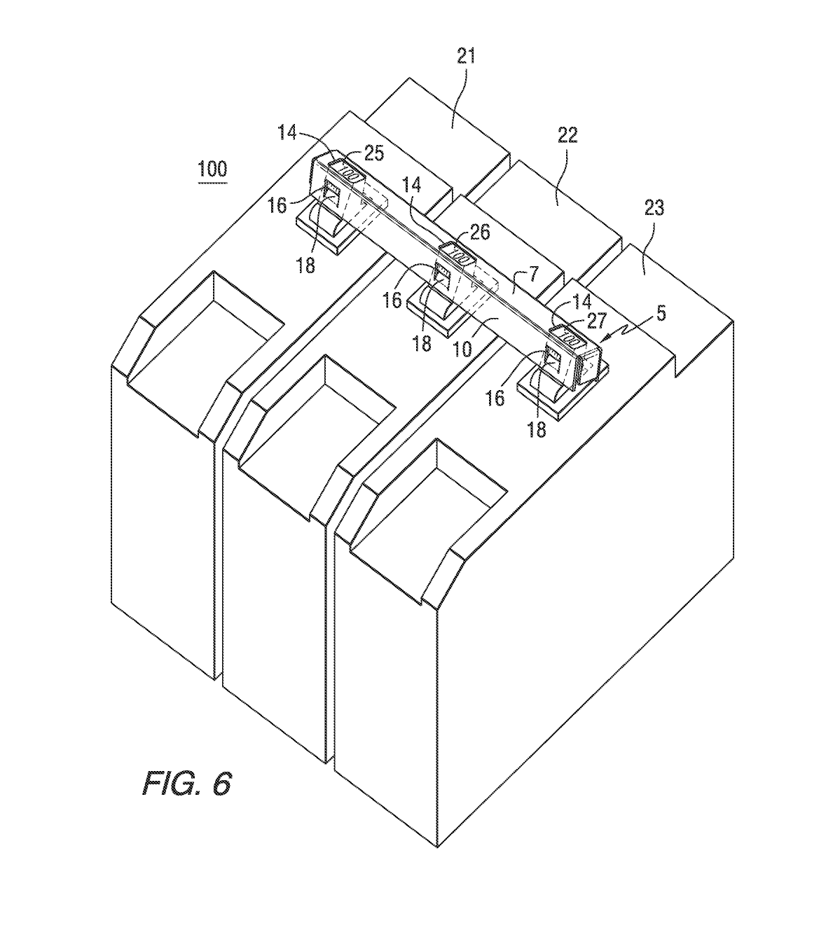

FIG. 5 shows a circuit breaker assembly 100 in accordance with certain embodiments of the disclosed concept. The assembly 100 includes a first circuit breaker 21, a second circuit breaker 22 and a third circuit breaker 23 arranged in a side-by-side relationship. Typically, the circuit breakers 21,22,23 are secured together by mounting on a common base (not shown). In certain embodiments, the circuit breakers 21,22,23 can be connected using a coupling mechanism (not shown). Each of the first, second and third circuit breakers 21,22,23 has a corresponding first, second and third handle operators 25, 26, 27, respectively, extending therefrom. The handle operators 25,26,27 are operable for switching between “on” and “off” positions. The handle operators 25,26,27 extend generally parallel to each other. The assembly 10 includes the handle tie 1 of FIG. 1, as employed on the handle operators 25,26,27 of the circuit breakers 21,22,23. In operation, the handle tie 1 slides over the top of the circuit breaker handle operators 25,26,27, in order that such handles fit through the top of the rectangular member 5 and are aligned with the corresponding plurality of apertures 14 to permit simultaneous operation of the circuit breaker handle operators 25,26,27. First, second and third amperage indications 30,31,32 are typically molded into first, second and third outer end faces 34,35,36 of first, second and third handle operators 25,26,27, respectively, and are clearly visible since the outer end faces 34,35,36 align with or extend into or through the apertures 14 of the handle tie 1.

FIG. 6 is an isometric view of the circuit breaker assembly 100 shown in FIG. 5. FIG. 6 includes circuit breakers 21,22,23, handle operators 25,26,27 as shown in FIG. 5. Further, FIG. 6 shows that each of the plurality of apertures 14 has associated therewith slots 16 positioned above and below each of the apertures 14, and the barbs 18 are configured, e.g., angled, bent or slanted toward the handle operators 25,26,27, to securely engage an end portion of each one of the handle operators 25,26,27.

While specific embodiments of the disclosed concept have been described in detail, it will be appreciated by those skilled in the art that various modifications and alternatives to those details could be developed in light of the overall teachings of the disclosure. Accordingly, the particular arrangements disclosed are meant to be illustrative only and not limiting as to the scope of the disclosed concept which is to be given the full breadth of the claims appended and any and all equivalents thereof.

What is claimed is:

1. A handle tie apparatus for connecting generally parallel handles of at least two electrical switching assemblies arranged in a side-by-side relationship, comprising:
a rectangular member having a trough shape open at a top and closed at a bottom thereof, a pair of opposing side walls and a pair of opposing end walls defining the rectangular member;
a plurality of apertures formed within the bottom of the rectangular member, the apertures adapted for receiving end parts of a corresponding plurality of electrical switching handles;
a plurality of slots firmed in each of the opposing side walls of the rectangular member, the slots in one of the opposing side walls are formed generally in locations which correspond to the slots in the other opposing side wall when aligned; and
a barb configured in each of the plurality of slots which is structured to receive and mechanically engage and secure a portion of the corresponding plurality of electrical switching handles.

2. The handle tie apparatus of claim 1, wherein the at least two electrical switching assemblies are circuit breakers.

3. The handle tie apparatus of claim 2, wherein the at least circuit breakers are G frame 1 pole breakers.

4. The handle tie apparatus of claim 1, wherein there are three electrical switching assemblies.

5. An electrical switching assembly adapted for multi-pole operation, comprising:
a first electrical switching assembly having a first handle extending therefrom for switching said first electrical switching assembly between “on” and “off” positions;
a second electrical switching assembly having a second handle extending therefrom for switching said second electrical switching assembly between “on” and “off” positions;
a mechanism to couple the first and second electrical switching assemblies together with said first and second handles extending generally parallel to each other; and
a handle tie to connect said first and second handles for simultaneous operation thereof, said handle tie comprising:
a rectangular member having a trough shape open at a top and closed at a bottom thereof, a pair of opposing side walls and a pair of opposing end walls defining the rectangular member;
first and second apertures formed within the bottom of the rectangular member, the first and second apertures adapted for receiving end parts of the first and second handles;
first and second slots formed in each of the opposing side walls of the rectangular member, the first and second slots in one of the opposing side walls formed generally in locations which correspond to the first and second slots in the other opposing side wall when aligned; and
a barb configured in each of the first and second slots, the barb structured to receive and mechanically engage and secure a portion of the corresponding first and second handles.

6. The electrical switching assembly of claim 5, further comprising a third electrical switching assembly having a third handle extending therefrom for switching said third electrical switching assembly.
